(19) United States
(12) Patent Application Publication
(10) Pub. No.: US 2005/0278088 A1
(43) Pub. Date: Dec. 15, 2005

(54) Method and apparatus for collision avoidance and enhanced visibility in vehicles

(76) Inventor: Craig Thorner, Jackson, NJ (US)

Correspondence Address: Craig Thorner, 35 Merion Lane, Jackson, NJ, 08527, US

(21) Appl. No.: 10/857,325

(22) Filed: May 29, 2004

(51) Int. Cl. B60K 28/10

(52) U.S. Cl. 701/28

(57) ABSTRACT

A method and apparatus for collision avoidance and enhanced visibility is disclosed which increases the safety of vehicles. The invention utilizes a modular and self-contained network of sensors and cameras affixed around the perimeter of a vehicle to detect and then make known to the operator of said vehicle currently present or impending threats to safety. The system tracks pedestrians and other objects in real time and performs analysis to reduce the quantity of information according to threat level, and presents the corresponding information to the vehicle operator in an intuitive manner such that safety is facilitated and maintained.

### FIELD OF THE INVENTION

This invention relates to vehicle collision avoidance systems, and, more particularly, to a means of preventing collisions and enhancing visibility in vehicles.

### BACKGROUND OF THE DISCLOSURE

Motor vehicle safety is a continually evolving status quo of many independent safety systems, such as three-point safety belts, crumple zones, driver and passenger airbags, side-door airbags, anti-lock brakes, traction control systems, daytime running lights, and more. Even given the whole history of ever-improving motor vehicle safety, the perpetual need for safer vehicles has only just begun to advance the implementation of useful collision avoidance systems and enhanced visibility systems. Most of the improvements in motor vehicle safety are directed toward small passenger vehicles and are not applicable to (nor economically feasible in) larger vehicles such as busses and trucks. Due to the irreducible physical form of a large vehicle, and the relatively small size of a pedestrian, it is often the case that the driver of a large vehicle can not see well enough around the perimeter of the vehicle to be sure it is safe to begin or continue operating the vehicle. From the perspective of the pedestrian, the most dangerous part of transporting one's self on a large passenger vehicle (such as school busses and passenger busses) is entering and exiting the vehicle. For large passenger vehicles, at any given stop along a route there is always the possibility of late-arriving passengers making haste to catch the vehicle before it departs along its route, and therefore, presenting various safety hazards. Furthermore, also at any given stop along a route, there is always the possibility of departed passengers lingering close to the perimeter of the vehicle, and likewise presenting various safety hazards. The reasons for safety hazards thus presented by pedestrians (within the scope of their entrance and exit to the vehicle in question) are numerous and unpredictable by their very nature, and can be linked to accident, inattention, clumsiness, weather conditions, illness, and the like. Larger vehicles exacerbate the problem due to their inherent poor visibility with respect to their entire perimeter, and make it difficult for the operator to know if the perimeter of the vehicle is clear, and ultimately, if it is safe to proceed each time so confronted by numerous stops along a route. Therefore, a need exists in the art for a system that increases the safety of pedestrians as they enter, exit, and otherwise move in and around the perimeter of larger vehicles by increasing their visibility such that the operator of the vehicle can be properly aware of their presence.

Prior art relevant to the present invention includes U.S. Pat. No. 6,337,637 B 1 filed on Oct. 20, 2000 entitled “Collision with Pedestrian Prevention System”. In this example of prior art, information related to pedestrians and/or other obstacles are gathered by “on-road” sensing means that exists wholly outside and totally apart from the vehicles using the disclosed system, wherein the vehicles receive data regarding pedestrians and/or other obstacles by “on-road road-to-vehicle communication means”. In column 2 line 52 the issued U.S. Pat. No. 6,337,637 B1 states: “On-road road-to-vehicle communications means is means for communications between the on-road equipment and a vehicle, and in this system, the on-road road-to-vehicle communications means sends information concerning pedestrians, road surface conditions, and road line form . . . ” A few sentences earlier in column 2 line 45 it states: “The on-road processing means is the most important means among the various types of means provided on a road in this system, and estimates a pedestrian's behavior from road line form information stored in the database beans [sic] (note: the word “beans” is from the original verbatim but presumably was intended to have been spelled “means”) as well as from the information concerning the pedestrian's position and wailing speed collected by equipment provided on the road.” The invention disclosed in the preferred embodiment of the present patent application does not utilize data sensing means that are physically separated from the vehicle to which the present invention has been affixed, and therefore, is innovative with regard to the prior art in U.S. Pat. No. 6,337,637 B1.

Prior art relevant to the present invention also includes U.S. Pat. No. 6,035,053 filed on Sep. 30, 1997 entitled “Moving Subject Recognizing System for Automotive Vehicles”. In this example of prior art, the system is invented to prevent vehicle-pedestrian collisions in the area limited to the forward path of a given vehicle by scanning the area in front of the vehicle and extracting from sensed data the lateral velocity of a discovered pedestrian, such that if the pedestrian's lateral velocity would place the pedestrian within the bounds of a predicted future path of travel of the vehicle, the collision prevention measures would be activated. The invention of U.S. Pat. No. 6,035,053 only prevents collisions with pedestrians that occupy the area in front of the given vehicle, where the pedestrian would be struck by the moving vehicle if it continued along its path of future incidence with the given pedestrian. The invention disclosed in the preferred embodiment of the present patent application does not utilize a limited forward area of scanning, but rather creates a full perimeter of coverage in all directions, including the sides and rear of the vehicle to which the present invention has been affixed. Furthermore, it is not necessary for the invention disclosed in preferred embodiment of the present patent application to detect moving pedestrians in a forward path of the vehicle while in motion, because it can also prevent collisions with pedestrians that are stationary and dangerously close to the perimeter of the vehicle to which the present invention has been affixed, while said vehicle is at a full stop, wherein the presumed danger would occur if said vehicle began to move along its intended path from its full stop while the stationary pedestrian was in close proximity to the perimeter of said vehicle. Therefore, the present invention is innovative with regard the prior art in U.S. Pat. No. 6,035,053.

### SUMMARY OF THE INVENTION

The present invention provides a method and corresponding apparatus for enhancing the visibility and improving the safety of pedestrians when entering, exiting, and moving within and around the perimeter of larger vehicles. More specifically, the innovative method of the present invention utilizes standardized and self-contained modular pieces that connect end-to-end and easily fasten around the perimeter of large vehicles of varying sizes. Due to the modular nature of the sections, the overall length and width of the vehicle is accommodated simply by the number of modules utilized. Special sections are utilized to negotiate the right angles at each corner of the perimeter (i.e., where the sides and back of the vehicle meet) and the “less-than-standard-module” lengths at the remainder of any given side of the vehicle to which the present invention has been affixed. The modules are straight sections of plastic or metal with embedded electronics to accommodate sensors for scanning physical areas for pedestrians and obstructions and gathering data from said scanning, video cameras for frame capture and gathering visual data for analysis and subsequent display, and electronic means for communicating both to and from a main control unit that analyzes data from all the standardized modular sections that are all interconnected around the perimeter of a vehicle to which the present invention has been affixed. The standardized modular sections enumerate into an electronic network of fixed perimeter and report their configuration to a main control unit. The main control unit manages the network embodied by all the modular sections and determines which area (if any) of the perimeter of the vehicle requires closer analysis by the operator of the given vehicle. When the main control unit determines that an area of the vehicle's perimeter requires further scrutiny, it requests the video data from the video camera with the most appropriate view of the area in question and displays that video on a video display (conveniently located for the vehicle operator), along with a top down view of the perimeter of the vehicle with the area of video highlighted so the operator can immediately and easily reconcile the area to which the provided video corresponds. Should multiple areas of the perimeter require video scrutiny, the display would be divided into smaller sections, where each section displays a full frame from the given area. The system provides various alarms to ensure that the vehicle operator understands the present threat to pedestrian safety, as well as having the capability to override the operator's inadvertent or intentional disregard for the condition that triggered the alarm with regard to the system's perceived lack of safety. The vehicle would not be able to proceed until and unless the danger is passed or had been otherwise mitigated, or the system was manually overridden by the operator of the vehicle.

### BRIEF DESCRIPTION OF THE DRAWINGS

The teachings of the present invention can be readily understood by considering the following detailed description in conjunction with the accompanying drawings, in which:

FIG. 1 is a block diagram of an illustrative embodiment of a perimeter module of the present invention;

FIG. 2A is a block diagram of an illustrative embodiment of a completed perimeter of modules around the perimeter of a vehicle, further including a main control unit, display apparatus, and egress monitor;

FIG. 2B is the diagram of FIG. 2A wherein the varied perimeter modules comprise a unified perimeter network;

FIG. 2C is a block diagram that depicts an illustrative data acquisition area that is amenable to the pedestrian sensors and video cameras of the perimeter network, wherein the data acquisition area so depicted occurs simultaneously on the front, back, and left and right sides of the given vehicle;

FIG. 3A is a block diagram depicting a pedestrian within the data acquisition area of the perimeter network, wherein said pedestrian is substantially in front of the sensing means;

FIG. 3B is a block diagram depicting a pedestrian within the data acquisition area of the perimeter network, wherein said pedestrian is oblique to the sensing means;

FIG. 4A depicts an illustrative embodiment of a threat display compiled from data gathered by the perimeter network of the present invention;

FIG. 4B depicts an illustrative embodiment of a video display, wherein the displayed video is from a single video source from within the perimeter network of the present invention;

FIG. 4C depicts an illustrative embodiment of a video display, wherein the displayed video is from three video sources from within the perimeter network of the present invention;

FIG. 5 is a flow chart diagram depicting the illustrative high-level function of the main control unit of the present invention;

To facilitate understanding, identical reference numerals have been used, where possible, to designate identical elements that are common to the figures.

### DETAILED DESCRIPTION OF THE DRAWINGS

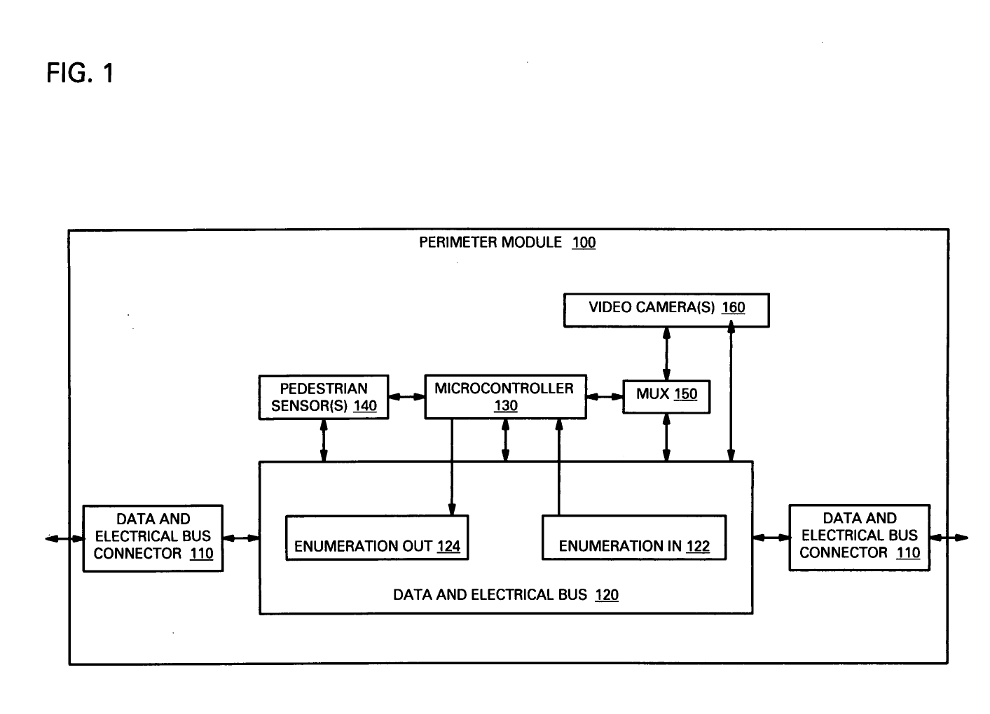

FIG. 1 is a block diagram of an illustrative embodiment of a perimeter module 100 of the present invention. The perimeter module 100 is substantially a long and thin rail with space inside to accommodate the components depicted in FIG. 1. Perimeter modules are so named because they are modular in nature by way of the matching data and electrical bus connectors 110 at each end that allow one perimeter module 100 to plug into the next nearest, and ultimately, to form a contiguous line of perimeter modules 100 around the perimeter of any given “larger vehicle”. The terms “larger vehicle” are meant to indicate vehicles larger than typical passenger cars or SUVs, inclusive of school busses, passenger busses, eighteen-wheel trucks, trains, and the like. For the purpose of this disclosure, the preferred illustrative embodiment employs a typical full-size yellow and black school bus as the “larger vehicle”, although no limitation is to be inferred as to the vehicle type to which the present invention may be affixed. The preferred illustrative embodiment of a typical perimeter module 100 would be an eight foot long by two inch tall by one inch thick “rail” containing the components of FIG. 1.

Still referring to FIG. 1, within the perimeter module 100 the data and electrical bus connectors 110 are connected by a data and electrical bus 120 which provides connectivity to all the components in FIG. 1, and connectivity to any and all additional perimeter modules 100 that are connected to either end of the single perimeter module 100 of FIG. 1 by way of the same data and electrical bus connectors 110. The components 130,140,150,160 within the single rail section (perimeter module 100) of FIG. 1 together form a self-contained electrical apparatus that is powered by and communicates via the data and electrical bus 120 of the perimeter module 100. The further functioning of the additional components (122, 124, 130, 140, 150, 160) of FIG. 1 will be explained further in this disclosure.

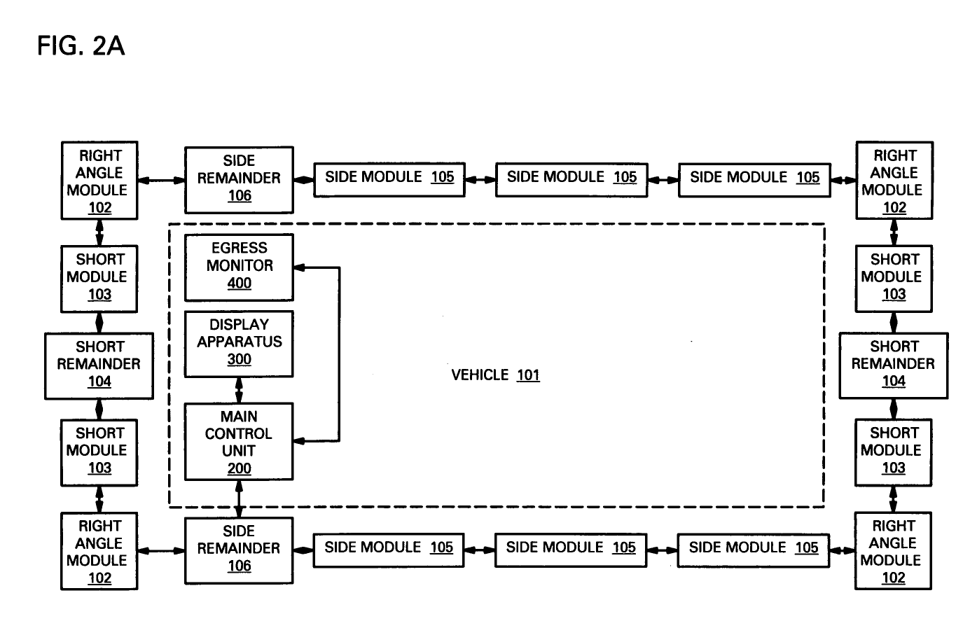

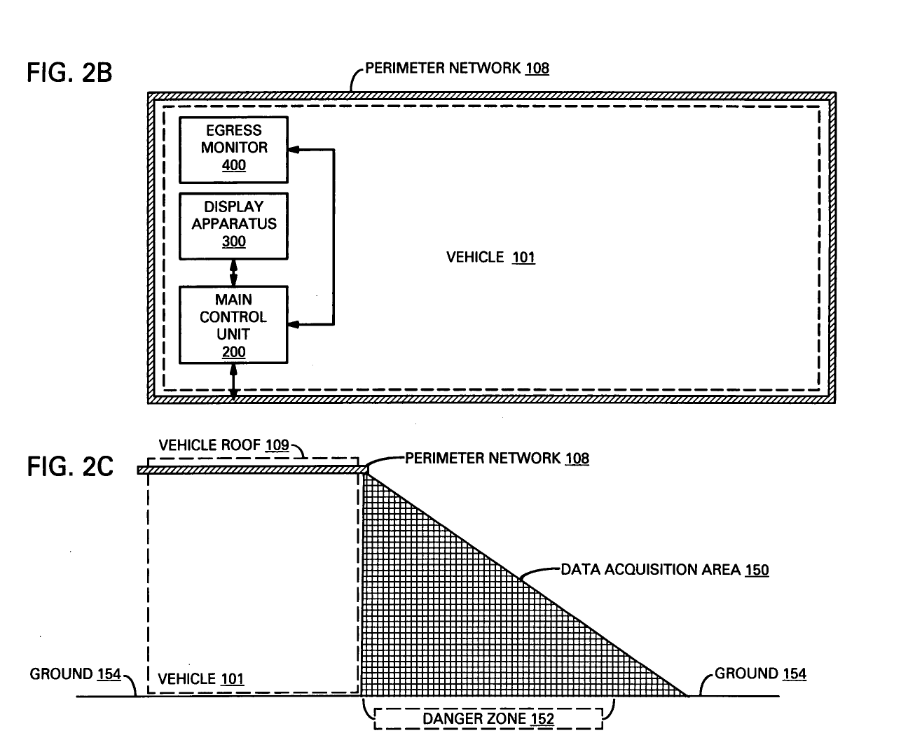

For ease of understanding we refer now to FIG. 2B, wherein a “unified” perimeter network 108 is affixed to the perimeter of a vehicle 101. Referring now to FIG. 2A, the unified perimeter network 108 of FIG. 2B is shown as an assemblage of various perimeter modules 102, 103, 104, 105, 106. It is necessary to have different types of perimeter modules 100 to accommodate vehicles 101 of varying sizes as well as the typical four corners of the vehicle 101. It is to be understood that the perimeter network 108 is to be ruggedized by design for all weather conditions and robust use in the field under varying environmental conditions. This can be achieved by well known means common to outdoor electrical systems and components. More specifically, the data and electrical bus connectors 110 of FIG. 1 are expected to be weather-proofed (e.g., gaskets and the like at each connection point) such that moisture can not infiltrate and destroy the internal components of the perimeter modules 100. Should a given perimeter module 100 lose its functionality for any reason (e.g., normal wear and tear, expected end of life, breakage, and the like), it can readily be removed from the perimeter network 108 and replaced with an identical perimeter module 100, thus restoring the integrity of the complete perimeter network 108 of FIG. 2B.

In the presently preferred illustrative embodiment, a school bus of typical dimensions eight and one half feet wide and forty feet long is the vehicle 101 around the perimeter of which the varied perimeter modules 102, 103, 104, 105, 106 of FIG. 2A are affixed to yield the unified perimeter network 108 of FIG. 2B. In FIG. 2A, an illustrative installation would begin by installing the right angle modules 102 at each corner of the perimeter of the vehicle 101. The right angle modules are perimeter modules 100 that carry only the data and electrical bus connectors 110 and data and electrical bus 120 of FIG. 1 with the sole purpose of negotiating the corners of the given vehicle 101. The right angle modules 102 would also include a telescoping capability to allow each leg surrounding the 90 degree bend to extend such that connection to other modules can easily be made. By installing the right angle modules 102 at each corner of the vehicle 101 it will become easier to complete the unified perimeter network 108 of FIG. 2B.

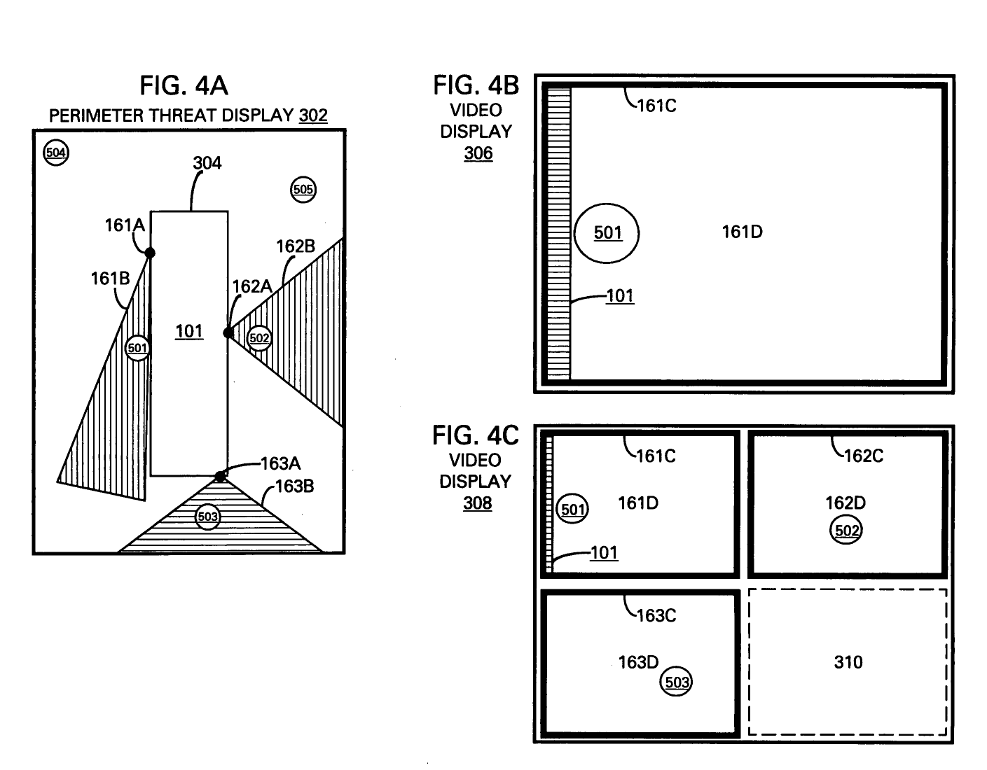

Referring again to FIG. 2A, the side modules 105 are, for this illustrative embodiment, each a length of eight feet. The illustrative school bus has an overall length of forty feet, and thereby requires five total units of side module 105 to complete the perimeter network 108 on the given side of the school bus (FIG. 2A only depicts three side modules 105 so the drawing is able to fit on one page). Ideally the five total units of side modules 105 would combine to form a length of forty feet and would align perfectly and connect directly to the right angle modules 102 previously installed at each corner of the vehicle. However, perfect alignment in multiples of eight foot lengths is unlikely given the different size of various vehicles. For example, assuming a given vehicle's side length is thirty five feet, where four individual eight foot sections yields a thirty two foot long assemblage of side modules 105, there would be a three foot remainder that is not long enough to physically fit a standard eight foot section. In these common cases where there would be a remainder of length along the side of a vehicle 101 that can not accommodate an additional eight foot side module 105, other size perimeter modules 100 would be available (such as the short module 103 of FIG. 2A) and interchangeable in any order so as to yield a good fit as required by the length of any given vehicle. Both the side remainder module 106 and the short remainder module 104 of FIG. 2A are effectively null sections carrying only the data and electrical bus connectors 110 and data and electrical bus 120 of FIG. 1 and are telescoping in nature such that the overall length of these remainder sections can be of a certain range, such as six inches to twelve inches for the short remainder 104 and twelve inches to twenty four inches for the side remainder 106. This telescoping configuration can be accomplished with a flexible circuit ribbon or wiring harness that is embedded within a telescoping remainder module 106, 104, and connected to both data and electrical bus connectors 110 such that slack exists (e.g., the flexible connector is enclosed in an “S” shape such that as the module is stretched the “S” shape unravels to become straighter as additional length is required). The nature of the telescoping remainder modules 106, 104 is achieved by nesting two or more sections of different sizes of housing within itself such that the sections can be pulled apart to make more length, while the “S” shaped internal wiring harness or internal flex-connector or flexible circuit board maintains the integrity of the data and electrical bus 120 that exists within the telescoping remainder modules 106 and remains connected to each data and electrical bus connector 110 regardless of the length so achieved within the maximum allowed length provided by the physical limitation of the remainder modules 106, 104. In addition to the telescoping configuration so described, there can also be non-telescoping null sections of varying sizes to allow varied length extensions to be fitted to standard size modules 106, 104 such that any given length can be accommodated. In the case of null sections and fixed size or telescoping remainder modules, methods can be utilized wherein the ultimate size of any given section is known to the microcontroller 130 that exists within each module by employing well known circuitry such as a slide type potentiometer within the telescoping section such that the microcontroller can accurately know the exact length of the section it is affixed within. In this manner, when the perimeter network 108 enumerates (more information about this further in this disclosure), the main control unit 200 would know the precise length of each module within a given side. This precise measurement is not ultimately necessary for the system to function, and function well at that, but it would allow for a more accurate display apparatus representation (302 of FIG. 4A) as well as more accurately determining which video camera (160 of FIG. 1) should be utilized to provide an appropriate view of a given area that requires scrutiny by the vehicle operator. However, cost and complexity issues may result in true null sections that only provide “pass through” functions with respect to the data and electrical bus 120 while simultaneously allowing a proper length to be achieved to fit a given vehicle's dimensions such that the perimeter network 108 is matched to the given vehicle. In summary, and in the case of an illustrative forty foot long school bus, five side modules 105 of eight foot length each would perfectly align into the right angle modules 102 at each corner of the two sides. In the case of a thirty five foot long school bus, four side modules 105 of eight foot length would provide thirty two feet of coverage with the three foot remainder being covered by either telescoping or fixed side remainder 106 modules.

Referring again to FIG. 2A, the short modules 103 and short remainders 104 are fixed to the front and rear of the vehicle 101 in the same manner as the side modules 105 and side remainders 106 were affixed to its sides, such that the perimeter network 108 is properly established. The reason for the two additional types of modules for the front and rear is that the front and rear sides of larger vehicles are shorter in length that the lateral sides, and therefore, require smaller size modules to reach across a given vehicle. In the illustrative embodiment, the short module 103 is four feet in length, in comparison to the side module 105 that is eight foot in length. However, both the side modules 105 and the short modules 103 are interchangeable and fully compatible when creating the perimeter network 108 of FIG. 2B due to the enumeration process that will now be explained.

Referring again to FIG. 2B, the vehicle 101 is affixed with a competed perimeter network 108 which is connected to a main control unit 200. The main control unit is essentially a computer that is connected to the perimeter network 108 as well as display apparatus 300 and egress monitor 400.

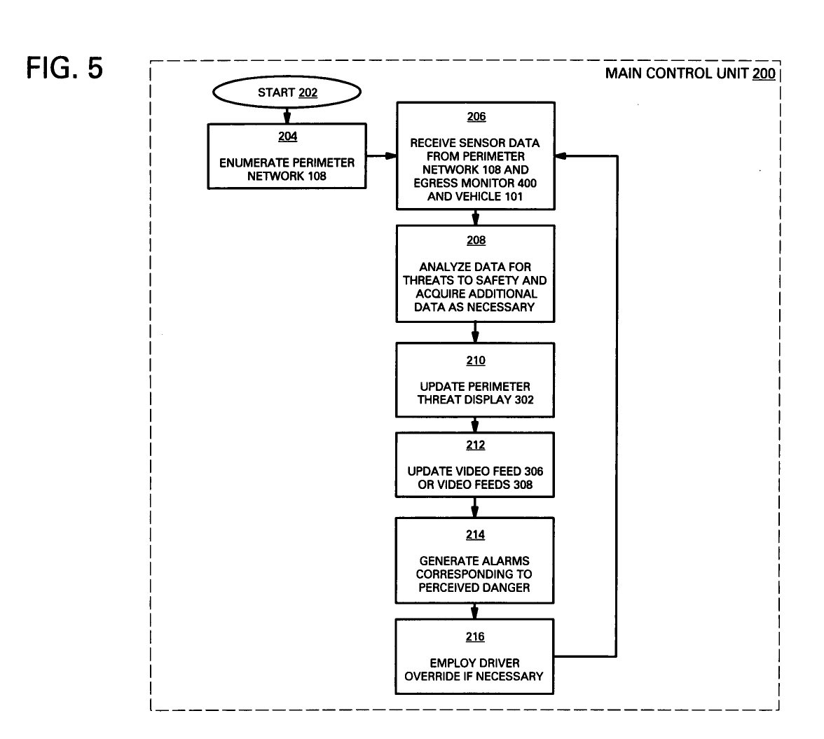

Referring ahead to FIG. 5, a flow chart is depicted that illustrates the function of the main control unit 200 of FIG. 2B. Upon power up, we start at step 202 and proceed to step 204 wherein the main control unit 200 enumerates the perimeter network 108 to understand its physical configuration. This is achieved by communicating with all the microcontrollers 130 in all the perimeter modules 100 of the perimeter network 108 by utilizing the enumeration in 122 and enumeration out 124 lines over the data and electrical bus 120 that is present throughout the perimeter network 108 via the data and electrical bus connectors 110. The enumeration serves the express purpose of allowing the main control unit 200 to know the physical configuration of the perimeter network 108 such that the location of the source of the data gathered from pedestrian sensors 140 and video cameras 160 can be known to the main control unit 200. Although many different ways of enumerating the perimeter network 108 layout can be utilized, the presently preferred embodiment uses an innovative means by dedicating one pin on the data and electrical bus 120 and the microcontroller 130 as the enumeration in 122 pin, and a separate pin as the enumeration out 124 pin. In this fashion, the main control unit 200 connects to a first microcontroller's enumeration in pin, but no others, because the enumeration in 122 pin on the next microcontroller 130 in the perimeter network 108 is connected to the enumeration out pin of the first microcontroller adjacent to the main control unit 200. It is agreed by the communications protocol that the default condition of each enumeration out 124 pin on each microcontroller 130 in the perimeter network 108 is a logical zero (hereafter zero volts), while each enumeration in 122 pin waits for a logical one (hereafter five volts) to appear before it allows itself to be catalogued into the known configuration of the perimeter network 108 by the main control unit 200.

In the illustrative embodiment, the main control unit applies a logical one signal to its enumeration out 124 line, which arrives at the first microcontroller 130 in the first perimeter module 100 adjacent to the main control module 200 via the data and electrical bus 120 that exists throughout the perimeter network 108. All subsequent microcontrollers 130 see the default condition logical zero, and therefore, do not participate in the enumeration. Any microcontroller 130 receiving the logical one on its enumeration in 122 pin then communicates to the main control unit 200 on the data and electrical bus 120 to the main control unit 200 and receives its numerical address, which, in this case, will be agreed to be the number 1. Once it receives its known address, it writes this value to an address register within its non-volatile EEPROM memory which is typically available in low cost microcontrollers. Now having a known address, the microcontroller 130 within the first perimeter module 100 adjacent to the main control unit 200 then reports a value or values that were encoded in its microcontroller software code at the point of manufacture or code loading (e.g., when the chip was “burned” or programmed with microcontroller code designed for its operation) that indicate its overall length, its number of pedestrian sensors 140, its number of video cameras 160, and any other data relevant to its configuration. This data can be represented by a single number that corresponds to a known index in a look-up table that is known to the software executing within the main control unit 200 such that the transferred data is very efficient. However, in the case of the previously disclosed telescoping modules that are of variable length, a specific value of length unique to the given module would be transmitted as well. This value can be determined in many ways and is not limited by this illustrative disclosure, however, typically a slide type potentiometer would change its resistance as its telescoping section was expanded, such that an analog to digital conversion could be performed to yield a resistance value, wherein the length could be calculated from said resistance value, or wherein said resistance value could be used as an index for a lookup table that was previously established and known to the main control unit 200.

After the enumeration of the first perimeter module 100 adjacent to the main control unit 200 is complete, the microcontroller 130 within said first perimeter module 100 sets its enumeration out 122 pin to an logical one output, which is then seen by the next microcontroller 130 adjacent to the first perimeter module 100, such that the second microcontroller 130 in the perimeter network 108 is now able to participate in the enumeration sequence and convey its configuration to the main control unit 200. Likewise, after the second microcontroller 130 completes its enumeration and receives and stores its known address, and makes its configuration known to the main control unit 200, it then sets its enumeration out 124 pin to a logical one output, which is then received by the enumeration in 122 pin of the next microcontroller 130 in the sequential line of all the perimeter modules 100 present in the compete perimeter network 108. This process repeats much like a domino effect, wherein each microcontroller having enumerated after receiving the logical one on its own enumeration 122 pin, then applies the logical one to its enumeration out 124 pin. In this manner the entire perimeter network 108 enumerates and receives an address equal in numerical value to its position in the perimeter network 108, while making its configuration known to the main control unit 200. Thus the perimeter network 108 becomes a closed loop, with each section being a self contained apparatus with respect to its internal functionality, all being mediated by the main control unit 200 by sending and receiving commands and data via the data and electrical bus 120 that is common to all perimeter modules 100, yet acted upon only by the perimeter module 100 that matches the address of said communication, each communication having an address in its protocol such that communication specific to any given perimeter module 100 can occur without hindrance within the perimeter network 108.

Referring now to FIG. 2C, the vehicle 101 is shown with respect to the ground 154, and with the perimeter network 108 affixed to the area just below the vehicle roof 109, such that the pedestrian sensors 140 and video cameras 160 embedded within each perimeter module 100 within the perimeter network 108 has its own data acquisition area 150. Each data acquisition area 150 in the presently preferred illustrative embodiment is afforded a top down view from just below the roof of the vehicle roof 109 to the ground 154 below, wherein each data acquisition area 150 encompasses the area adjacent to the perimeter of the vehicle 101 and out to some safe distance away from the dangerous perimeter of the vehicle 101, where the area so encompassed comprises a danger zone 152. With the perimeter network 108 in place and enumerated as previously described, a danger zone 152 is established around the entire vehicle, with each perimeter module 100 using its pedestrian sensors 140 and video cameras 160 to keep watch over its respective danger zone 152. With each perimeter module 100 having communication with the main control unit 200, the main control unit 200 is thereby provided full coverage of the vehicle's entire perimeter via the sum of all the individual danger zones 152 of each perimeter module 100 in the perimeter network 108.

Referring again to FIG. 5, having previously executed step 204 to enumerate the perimeter network 108, now step 206 is undertaken. In step 206, the main control unit 200 receives the available sensor data from the perimeter network as well as the egress monitor 400 and the vehicle 101. Referring back to FIG. 1, a perimeter module 100 has within it one or more pedestrian sensors 140, a multiplex switch (MUX) 150, one or more video cameras 160, and the microcontroller 130. The pedestrian sensor(s) 140 work in conjunction with the video camera(s) 160 to detect pedestrians or other safety hazards. The manner of operation of the pedestrian sensor(s) 140 can be widely varied based upon infrared sensing, ultrasonic sensing, laser sensing, radar sensing, and other means, and can be any combination of the forgoing. The ultimate source of safety analysis would be performed via video analysis by the main control unit 200 of the video feeds from the video camera(s) 160, and as well by the operator of the vehicle based upon the display apparatus 300 to be described later in this disclosure. However, the pedestrian sensor(s) 140 would be used to perform preliminary analysis of a given danger zone 152 to determine if the particular danger zone at any given time contains a threat to safety, whereupon more complex analysis and vastly increased resource utilization within the main control unit 200 would be undertaken to make further determinations with regard to possible threats to safety. In the preferred embodiment, the pedestrian sensor(s) 140 of a given individual perimeter module 100 can, without consulting with the main control unit 200, independently determine that no sufficient threat to safety exists at the time of sensing, and therefore, that no additional processing would be necessary by the main control unit 200 for the given individual perimeter module 100. However, should the pedestrian sensor(s) 140 determine an object or safety threat exists within its specific danger zone 152 at the time of sensing, the microcontroller 130 would assign a value indicative of the strength of the currently assessed preliminary threat, and would report that value to the main control unit 200 by way of the common data and electrical bus 120, while utilizing its enumerated address assignment such that the main control unit 200 would receive the assigned threat assessment value and would know the area to which the threat corresponded. With all the perimeter modules 100 within the entire perimeter network 108 reporting to the main control unit 200 in this fashion, the main control unit 200 then makes requests to receive the video feed or video feeds from the video camera or cameras 160 that have the best view of the danger area 152 so assessed as having the highest preliminary threat value. Within the data and electrical bus 120, there exists many parallel lines for video signal transmission, all entering the inputs of the MUX 150 within each perimeter module 100. When the video feed from a specific video camera 160 is desired by the main control unit 200, it makes a request of the microcontroller 130 at the previously enumerated address to configure the MUX 150 to switch the video camera 160 feed onto the data and electrical bus 120. In the presently preferred embodiment, there are four parallel video signal lines, each of two conductors such that the signal is a typical composite video feed of NTSC video quality. However, any other analog or digital video format can be utilized, and is not to be limited by this disclosure. If the video camera(s) 160 are digital in nature, or have the capability of generating digital video formats, these video output signals can travel by way of USB versions 1.x or 2.x, or IEEE1394 FireWire, 100 megabit or 1 gigabit Ethernet, or any other format that makes such transmission efficient and cost effective. In the presently preferred embodiment, the video camera(s) 160 are analog NTSC composite signals.

With the all the pedestrian sensor(s) 140 within the perimeter network 108 having performed independent scans of their respective danger zones 152, and each determining no threat or assigning a threat value to what has been sensed, and the threat values of all the perimeter modules 100 having been received by the main control unit 200, all or some portion of the highest threat assessed values would result in video feeds being switched onto the data and electrical bus 120 by way of the MUX 150 of each respective microcontroller 130 so instructed to do so by the main control unit 200. These video feeds would then be digitized and analyzed by the main control unit 200, all simultaneously or in multiplexed fashion, and, if multiplexed, the frame rate of said multiplexing to be determined by the processing capability of the main control unit 200 (where the main control unit 200 is essentially a computer). For example, if the main control unit 200 has the capability to digitize and analyze forty frames per second, four video sources could be digitized and analyzed at ten frames per second each, while two video sources could be digitized and analyzed at twenty frames per second each, while forty video sources could be digitized and analyzed at one frame per second each.

In the presently preferred embodiment, the analysis performed on the digitized frames is a pixel motion algorithm that compares one video source's sequential frame to the next from the same video source, in sequence and in substantial real time, and determines the approximate size of a moving or stationary object, and makes a determination as to whether the object is a known threat to safety or, if inconclusive, requires viewing by the operator of the vehicle 101. Such video analysis and subjective determination of the nature of objects (both moving and stationary) by computational algorithms is an evolving science and undoubtedly would improve over time and would be well known to those skilled in the relative art. Due to the non-proprietary off-the-shelf nature of the main control unit 200 in the presently preferred embodiment, and, the main control unit 200 being a typical IBM compatible computer at its core, improvement to such video analysis and threat determination is inevitable. However, and ultimately, the final analysis is to be done by the human operator of the vehicle, and therefore, flawless automated analysis of video feeds by the main control unit is not necessary for the present invention to be effective. For example, the pedestrian sensor(s) 140 can perform simple and well-known object detection by way of simple infrared motion detection, with the system functioning only during full stops of the vehicle, or simple sonar or radar echo location, or any other of many well known means, with the sole result being a preliminary analysis that “some object requires further scrutiny by the human operator of the vehicle”. This low level of detail is easily achieved without significant computational overhead and relies heavily on the simple display of the video feed from the given danger zone 152 corresponding to the area of preliminary analysis, and ultimately, the action of the human operator of the vehicle to maintain prudence and safety. In this regard the human brain does all the high-level processing required.

However, there is no doubt whatsoever that even the full contrary can be achieved by technological means, due to computing capabilities and technologies that become cheaper and more powerful all the time. It is conceivable without departing from the teachings of the present invention that the preliminary sensing level afforded by the pedestrian sensor(s) 140 can be eliminated entirely, having the present invention rely solely on computationally heavy video analysis of all the video frames captured by all the video cameras 160 within all the perimeter modules 100 throughout the entire perimeter network 108, and at a high frame rate. The pedestrian sensor(s) 140 ultimately serve the sole purpose of reducing the overall amount of computationally heavy video analysis required by algorithms executing within the main control unit 200 by avoiding altogether any video analysis with regard to any and all perimeter modules 100 that have no identifiable preliminary threats. Where and when there is no preliminary threat detected by the pedestrian sensor(s) 140 of any given perimeter module 100, there is no need for further scrutiny at any given point in time by subsequent video analysis or video display for the benefit of the vehicle operator, thereby vastly reducing the overhead occurring within the system required for a good result. It is to be noted, however, that sufficiently robust computing power would diminish the need to create computational efficiency incurred by the system's overhead.

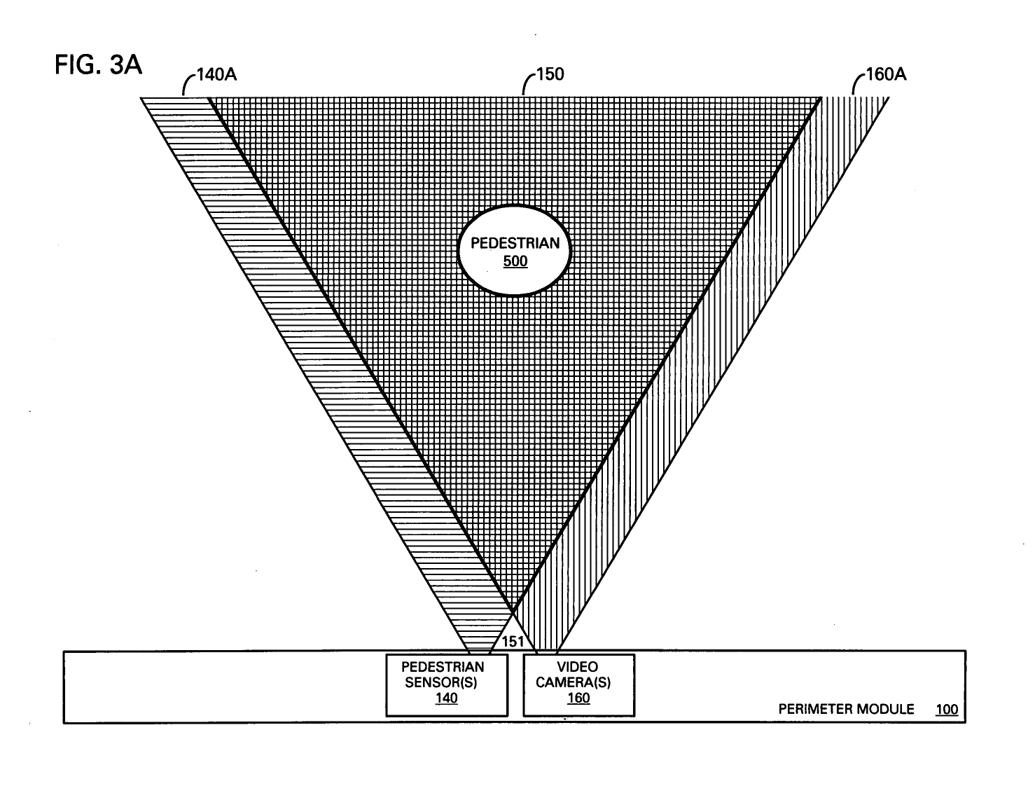

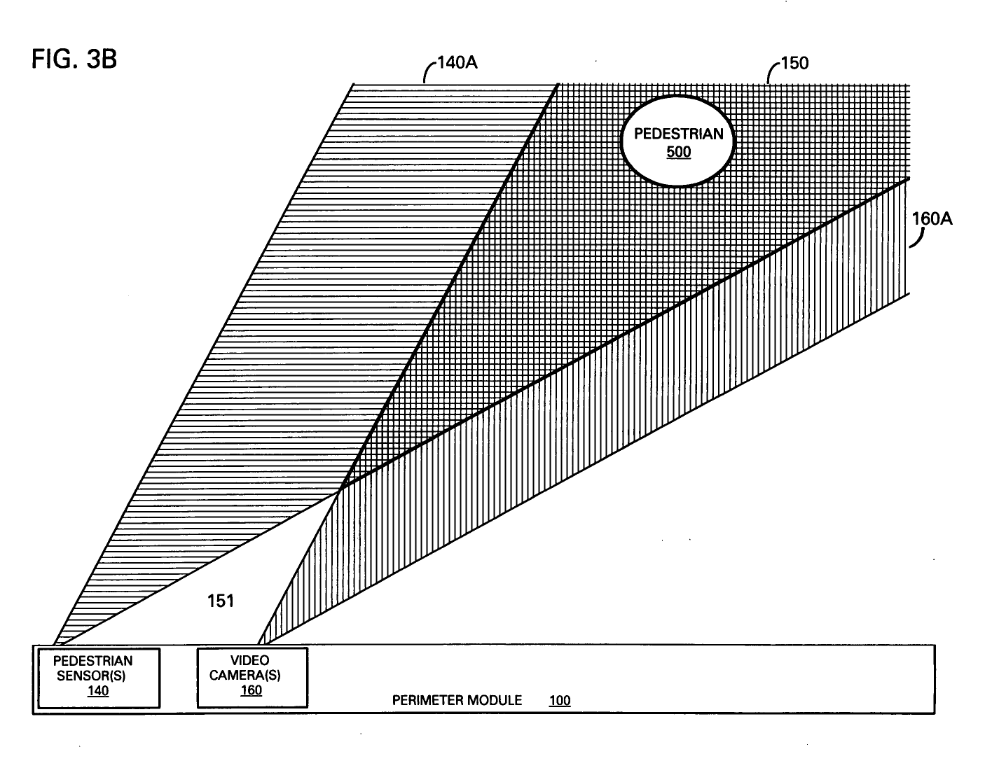

In the presently preferred embodiment, preliminary sensing is used to reduce the amount of computationally heavy video analysis required by any designated area of further interest. Referring now to FIG. 3A, a perimeter module 100 has both pedestrian sensor(s) 140 and video camera(s) 160 embedded within it. The pedestrian sensors 140 use a sensing means that is mediated by the microcontroller 130 as previously described. In this illustrative embodiment, the pedestrian sensors 140 use ultrasonic sensing, which is well known and used by measuring devices such as widely available ultrasonic measuring tools, commonly known as “ultrasonic tape measures”. Typically, these electronic devices emit narrow beams of sound waves that bounce off solid objects and reflect back to the emitter, which has a corresponding receiver. The time elapsed from when the sound was emitted to the time when it is received yields a measurement of distance to the object. In FIG. 3A, the pedestrian sensor 140 emits an ultrasonic sound that is depicted by cone 140A. The cone 140A so emitted corresponds to the data acquisition area 150 of FIG. 2C. If the data acquisition area 150 is empty and devoid of objects, it would return a steady value approximately indicative of the height of the perimeter network 108 relative to the ground 154 of FIG. 2C. Should an object be present with the danger zone 152 of FIG. 2C, the pedestrian sensor 140 would receive a value indicating the presence of the object. Referring back to FIG. 3A, the object existing within ultrasonic cone 140A is a pedestrian 500. The perimeter module 100 assigns a value to the object indicative of its perceived threat to safety and reports the value, so determined, to the main control unit 200 via the data and electrical bus 120 of the perimeter network 108. The main control unit 200, having compared the preliminary threat value to all others so reported, makes a request of the microcontroller 130 within the specific perimeter module 100 of FIG. 3A to provide the video from the corresponding video camera(s) 160. The field of view of the video camera 160, depicted as cone 160A, substantially overlaps with ultrasonic cone 140A, such that an object detected by any given pedestrian sensor 140 (e.g., any given preliminary sensing means) falls into a known corresponding video camera's field of view 160A. In FIG. 3A, the pedestrian is located within cone 150, which is the coincidence of the pedestrian sensor's ultrasonic cone 140A and the video camera's filed of view 160A. The microcontroller 130 used the MUX 150 to switch the video feed onto the data and electrical bus 120 such that it can be received by the main control unit 200 for further analysis and/or display via display apparatus 300.

Referring now to FIG. 3B, in all respects it is the same as FIG. 3A but demonstrates the ability of the system to detect and view objects oblique to the pedestrian sensor(s) 140 and video camera(s) 160. It is also the case that any given perimeter module 100 would have several pedestrian sensors and several video cameras, some projecting perpendicular to the vehicle as in FIG. 3A, or in an angle non-perpendicular to the vehicle as in FIG. 3B. Furthermore, in the case of at least two video cameras viewing the same object, analysis of the video feeds can allow the distance to the object to be accurately determined by comparison of the perceived changed position of the object (known as parallax) in the respective camera views. This is well known to those skilled in the art and is widely and reliably implemented to determine distance to objects.

In both FIGS. 3A and 3B, the area 151 between the two cones 140A and 160A, and wholly outside the area of cone 150, is the area where there is no incidence between the pedestrian sensor(s) and video camera(s). It is of course ideal to minimize this area of blindness to the extent possible, by way of overlapping areas of sensing means and/or well placed units of both pedestrian sensors 140 and video cameras 160.

Referring back to FIG. 5, step 206 also acquires data from the egress monitor 400 and the vehicle 101. The presently preferred embodiment is meant to function mainly during the many and repeated stops and starts of the vehicle 101 while attending its duties as a school bus. In such an illustrative capacity, the operation of the system can be suspended once the vehicle is in motion past some minimum speed. For example, if the vehicle 101 is traveling faster than 20 MPH, there is very little likelihood of pedestrians entering or exiting the school bus. However, as the school bus comes to a stop along its route, the system would automatically return to operation during the stop, allowing all its functionality to increase the safety of all passengers as they ambulate in and around the perimeter of the vehicle, and enter and exit the vehicle. Data from the vehicle 101 would allow the system to automatically change its mode of operation based upon the current state of the vehicle. The egress monitor 400 is a simple counter that keeps track of pedestrians as they exit the vehicle. It can be a simple and well known turnstile system, or a beam of light that is interrupted as each passenger exits the vehicle 101. With the count of departed passengers now known to the system, the pedestrian sensors 140 and video cameras 160 can be used to locate each pedestrian as they depart the monitored perimeter of the vehicle. These moving targets can be likened to blips on a radar screen with respect to the given pedestrian sensor. Currently, low-power radar chips are being developed outside the scope of this invention, and their usefulness is foreseen as a means of tracking the known count of departed passengers while they exit the perimeter of the vehicle. Such a system would do well to aid in the display of departed pedestrians. Currently, this capability would be achieved by video analysis in conjunction with the known count of departed passengers via the egress monitor 400. Furthermore, it is also foreseen that radio frequency ID (RFID) tags can be made part of a bus pass or badge that passengers or school students would have issued to them, where such devices could be easily tracked by the egress monitor 400 and pedestrian sensors 140 to enhance the present invention. No limitation should be inferred as to the means of pedestrian sensing or mode of operation of such tracking or egress monitoring (or ingress monitoring) as such things are being improved and invented all the time.

Referring back to FIG. 5, step 208 has the main control unit analyzing all the received data for threats to safety and acquiring additional data as necessary. This has been previously disclosed as the means by which the data acquired by all the pedestrian sensors 140 and video cameras 160 is made efficient such that the raw quantity of data is not overwhelming with respect to the computational capabilities of the main control unit 200. In the presently preferred embodiment, the pedestrian sensors 140 use ultrasonic sensing means to determine if objects are present within their respective data acquisition areas (150 of FIGS. 2C and 140A of FIGS. 3A and 3B). Should object(s) of sufficient score be detected by said pedestrian sensors 140, the main control unit 200 requests, by way of the data and electrical bus 120 and the previously disclosed enumeration process, that corresponding video be switched onto the data and electrical bus 120 by the corresponding microcontroller(s) 130 and their respective MUX(s) 150. This is done to keep the relatively heavy video traffic and subsequent video analysis (if any) to a minimum to reduce the overall system complexity and overhead. Therefore, step 208 is where the preliminary sensing is used to create focus on perceived threats to safety while ignoring areas devoid of relevant objects.

Referring now to step 210 of FIG. 5, the main control unit 200 updates the perimeter threat display 302 which can be seen in FIG. 4A. The perimeter threat display 302 of FIG. 4A and the video display 306, 308 of FIGS. 4B and 4C are both components of the display apparatus 300 of FIG. 2B.

The display apparatus 300 of FIG. 2B is the means by which information gathered by the perimeter network 108 is displayed for the operator of the vehicle 101. In the presently preferred embodiment, readily available TFT LCD flat panel displays are utilized. The two display types depicted in FIGS. 4A, 4B, and 4C can each exist on physically independent displays, or can share a single display. In the case of two separate displays, both may be 5 inch diagonal measure TFT LCDs of standard resolution 640×480 pixels in a typical 4:3 width-to-height ratio display type, wherein the display depicted in FIG. 4A would be oriented in well known portrait fashion (e.g., oriented more tall than wide) for better correspondence with the shape of the vehicle's perimeter 304, and the display depicted in FIGS. 4B and 4C would be oriented in well-known landscape fashion (e.g., oriented more wide than tall) for better correspondence with the shape of NTSC video. The two separate displays would typically be mounted together and in a convenient location for viewing by the vehicle operator. Any input required by the presently preferred embodiment from the vehicle operator (or during the installation and configuration of the system) would be accommodated by utilizing readily available touch-screen TFT LCDs. If one single physical display was utilized for displaying each of the two types of displays of FIGS. 4A, 4B, and 4C, a single wide screen 7 inch diagonal measure touch-screen TFT LCD could be used in lieu of the two previously described displays. Typically, a wide screen TFT LCD is of ratio 4.8:3 width-to-height. This display type provides a larger screen area compared to the 640×480 4:3 screen above. Presuming the equivalent display at ratio 4.8:3 would utilize 768×480 pixels, this would allow, for example, the display depicted in FIG. 4A to occupy the leftmost 128×480 pixels, and the display depicted in FIGS. 4B and 4C to occupy the rightmost 640×480 pixels. This would allow one single wide screen TFT LCD to show the perimeter threat display 302 of FIG. 4A and the video display 306, 308 of FIGS. 4B and 4C simultaneously. Of course the precise organization of the data displayed on any given display apparatus 300 employed by the system can be varied to optimize the information that is so provided to the vehicle operator, and no limitation should be inferred with regard to the information so displayed. As for the location of the display apparatus 300 within the viewing area amenable to the vehicle operator, the presently preferred embodiment employs a dashboard mounted 7 inch wide screen touch-screen TFT LCD. An alternative location would be to mount the given TFT LCD on the sun visor, such that the vehicle operator can have the displays readily available just by flipping the sun visor downward, thereby making the TFT LCD viewable, and, as well, unobtrusive. With regard to the location and type of display apparatus 300 utilized by the system, no limitation is to be inferred, and many different readily available display solutions can be employed without departing from the teachings of the present invention.

Referring again to FIG. 4A, the display apparatus 302 shows the perimeter 304 of the vehicle 101. This perimeter is to scale based upon the enumeration process which previously provided the length of all the perimeter modules 100 in the perimeter network 108. In FIG. 4A, a first pedestrian 501 falls within the field of view of a first camera 161A. The camera 161A is represented by a circle superimposed on the perimeter 304 of the vehicle 101 in a location that approximates the corresponding location of the actual camera 161A within the perimeter network 108. The approximate field of view of the first camera 161A is represented by a cone 161B, which is color shaded such that it is easily differentiated from other areas of the perimeter threat display.

Referring back to FIG. 5, in step 212 the main control unit 200 updates the video feed display 306. Referring now to FIG. 4B, the results of step 212 are seen. In FIG. 4B, the perimeter of the display 306 is highlighted with a border 161C of a color that is matched to the color of field of view cone 161B of FIG. 4A. In this manner the view that is seen in FIG. 4B is easily matched to the corresponding camera and field of view indicated on the perimeter threat display 302 of FIG. 4A. In FIG. 4A, the first pedestrian 501 is represented by an icon representing a pedestrian 501. On FIG. 4B we see the video feed from camera 161A, where the view 161D corresponds with the field of view cone 161B emanating from camera 161A. In FIG. 4B we see the actual image of the first pedestrian 501. On the left side of the view 161D we can see the side of the vehicle 101. Ultimately, the nature of the perimeter threat display 302 depicted in FIG. 4A allows the operator of the vehicle 101 to very quickly understand the location and view displayed in the video display of FIG. 4B such that quick and accurate threat assessment can be made by a human operator without struggling to reconcile the displayed camera view 306 with the myriad cameras contained within the perimeter network 108. In the case where a single camera is generating a video feed for the video display of FIG. 4B, only one corresponding field of view cone will appear on FIG. 4A.

Again referring to FIG. 4A, a second pedestrian 502 is captured by video camera 162A and so indicated within field of view cone 162B. Cone 162B is color coded to be different in color that cone 161B. Likewise, a third pedestrian 503 is captured by camera 163A and indicated within field of view cone 163B. Two pedestrians 504 and 505 were known to be in the monitored perimeter of the vehicle 101, and are indicated on the display, but presented no apparent threat to safety due to their position within the driver's natural field of vision. Having been counted by the egress monitor 400, their departure from the area is tracked on the perimeter threat display 302 but no video feed is assigned to track them due to the other more important threat scores assigned to the pedestrians 501, 502, and 503. Nonetheless, their presence is tracked by icons as they depart the area. In this manner the perimeter threat display 302 shows each pedestrian's presence as they ambulate about the perimeter. Emerging threats would fall under video scrutiny as necessary and in real time.

Referring now to FIG. 4C, the video display 308 shows a divided configuration where three different video feeds are shown. The upper left quarter of the display shows the same view 161D as FIG. 4B. In the upper right area, the view 162D is bounded by a border 162C which is color coded to match field of view cone 162B emanating from camera 162A on the perimeter threat display 302. Pedestrian 502 is seen in view 162D and is indicated by a corresponding icon 502 on the perimeter threat display 302.

Continuing with FIG. 4C, the lower left view 163D is bounded by border 163C which is color coded to match field of view cone 163B emanating from camera 163A as indicated on the perimeter threat display 302. Pedestrian 503 is seen in view 163D and is indicated by a corresponding icon 503 on the perimeter threat display 302.

The lower right area of FIG. 4C is empty because no fourth threat was determined to have a high enough score to further clutter the view in 4C. In most cases, and at most times, the video display would show a single source at a time based upon the most dangerous threat to safety. Typically one threat to safety is enough to halt the progress of the vehicle 101, and therefore, multiple threats would not often be displayed. This could of course be configured by operator preference. In any case the iconography and color coded filed of view cones are all implemented to help the human operator easily and quickly reconcile a given video feed to its precise location and orientation with regard to the operator's own position and the perimeter of the vehicle 101 so that safety can easily be maintained.

Referring again to FIG. 5, we proceed to step 214, where alarms are generated to alert the operator to perceived danger. These alarms can be auditory, visual, or tactile. Due to the main control unit 200 having knowledge of the location of a given threat to safety, an information rich auditory warning such as “DANGER ON YOUR LEFT SIDE, DO NOT PROCEED” or “THREE PEDESTRIANS ARE ON THE RIGHT, PROCEED WITH CAUTION” can be played for the driver's awareness, as well as the obvious buzzers or sirens. In addition, speakers can be included within the perimeter network 108 such that messages can be directed directly toward pedestrians that are lingering in the danger zone 152 within the data acquisition area 150 of FIG. 2C. Visual warnings can be incorporated in the display apparatus 300 as well as additional illuminated signs within the operator's field of view, such as a “WARNING” sign that lights up brightly to indicate the operator's need to consult the more detailed display system 302, 306, 308. In addition, vibratory actuators can be embedded in the driver's seat that would create tactile indications of obstructions on either side of the vehicle. In short, any method of gaining the operator's attention to present danger can be utilized.

Still referring to FIG. 5, step 216 employs automatic driver override if necessary. Driver override is meant to be any system which imposes its own judgment against the will of the driver. This may be necessary if the system believes the danger is so apparent that a full controlled stop of the vehicle is required and/or must be maintained, and to halt further progress of the vehicle until safety is assured. For example, automatic driver overrides could be implemented by a hydraulic mechanism on the brake line that would apply and maintain the brakes until a safety threat has passed while simultaneously disengaging the throttle. It is likely a manual bypass means for contradicting the automatic driver override would be provided for the vehicle operator should the system assess danger inaccurately or perceive false threats to safety.

Inevitable improvements to the various components and systems comprising the present invention are foreseen and appreciated. Any manner of technological advancement can be utilized by the systems of the present invention without departing from the teachings herein. For example, thermal imaging solutions (and other systems) exist today that can make the sensing means of the present invention (e.g., the pedestrian sensors 140 and video cameras 160 of the perimeter modules 100) impervious to inclement weather such as fog, rain, snow, and the like. In addition, night vision systems (including low light and zero light systems) can allow the present invention to function without regard to any given available level of illumination. The pedestrian sensing means 140 can be made to utilize any new and innovative object sensing solution that is developed. The visual system 160 can be made to utilize any new video analysis solution that is developed. The perimeter network 108 can be made to use wireless modules that communicate directly with the main control unit 200 without requiring the interconnections of a unified perimeter network 108 as depicted in FIG. 2B. Solar power can be used to charge internal batteries that power each perimeter module 100 such that no connection to the vehicle's power is required. Wide field-of-view systems can substantially reduce or otherwise minimize the number of modules required to establish a full perimeter of protection around a given vehicle. The system can be made applicable to smaller vehicles, such as passenger cars, for example, as an aid to parallel parking, wherein the perimeter modules 100 would be video cameras 160 above each wheel well and looking down toward the street, as well on the front bumper and rear bumper of the vehicle 101, while the display apparatus 300 would automatically show nearing obstacles as perimeter threats on the perimeter threat display 302, while the video display 308 would show real time video of each wheel nearing an object or the view from the front or rear bumper of the vehicle 101, such that complete situational awareness of the parking attempt would be readily available to the operator of the vehicle 101, without departing from the teachings of the present invention. Accordingly, the described embodiments are to be considered in all respects only as illustrative and not restrictive.

Although various embodiments which incorporate the teachings of the present invention have been shown and described in detail herein, those skilled in the art can readily devise many other varied embodiments that still incorporate these teachings. Therefore, it is to be understood that nothing shall be construed as a limitation of the present invention, other than the structure recited in the appended claims.

1. A system for avoiding collisions between vehicles and other objects, said system comprising:
a plurality of data gathering means fitted primarily to the perimeter of a vehicle;
an analysis means for analyzing data gathered by said data gathering means and determining existing and/or potential threats to safety;
display means for displaying data gathered by said data gathering means; and/or
display means for displaying depictions of data as determined by said analysis means.

2. The system of claim 1 further comprising:
an alerting means for alerting the vehicle operator to threats to safety as determined by said analysis means, such that the vehicle operator can be alerted to take corrective action and thereby maintain safety.

3. The system of claim 2 further comprising:
an operator override means whereby the inputs by the operator upon the vehicle can be overridden, should such action be deemed necessary by said analysis means;

4. The system of claim 3 further comprising:
a manual override means whereby the vehicle operator can manually override the operator override means, should such action be deemed necessary by the vehicle operator.

5. The system of claim 1, wherein the plurality of data gathering means is comprised by interconnecting modules.

6. The system of claim 1, wherein the plurality of data gathering means utilizes visual sensing means.

7. The system of claim 1, wherein the plurality of data gathering means utilizes acoustic sensing means.

8. The system of claim 1, wherein the plurality of data gathering means utilizes radio sensing means.

9. The system of claim 1, wherein the plurality of data gathering means utilizes light sensing means.

10. The system of claim 5, wherein said interconnecting modules are comprised by different lengths of straight sections; and
right angle sections for negotiating right angles at corners of said perimeter of said vehicle.

11. The system of claim 1, wherein said interconnecting modules are affixed to said perimeter of said vehicle and form a unified data gathering network around said perimeter of said vehicle.

12. The system of claim 11, wherein said unified data gathering network uses an enumeration means to automatically convey its configuration to said analysis means.

13. The system of claim 1, wherein said analysis means utilizes video processing algorithms to determine the presence of pedestrians or objects.

14. The system of claim 1, wherein said analysis means utilizes phases, comprised by:
a first phase for identifying areas that require further analysis; and
a second phase for detailed analysis of said identified areas requiring further analysis.

15. The system of claim 14, wherein said first phase of analysis occurs within each interconnecting module, by way of an internal processing means.

16. The system of claim 1, wherein said data gathering means are video cameras; and
said display means displays live video from said video cameras.

17. The system of claim 1, wherein said display means displaying depictions of data as determined by said analysis means is comprised by:
displaying a rendered perimeter approximating the shape of said perimeter of said vehicle; and
displaying icons representing detected objects of interest, said objects having been determined to be present by said analysis means, wherein said icons are displayed in a position relative to the rendered perimeter corresponding to their location relative to the actual perimeter of said vehicle.

18. The system of claim 17, wherein said data gathering means is comprised at least partially by video cameras, wherein each video camera yields a unique video feed, further comprising:
color-coded cones representing the approximate field of view of each video camera having the best view of said detected objects of interest, wherein said best view is determined by said analysis means;
an icon representing said video camera at the origin of each said field of view cone, wherein said camera icon is depicted on the rendered perimeter in a position corresponding to the location of said video camera on said vehicle; and
a video display with one or more color-coded bordered areas, wherein said color-coded bordered areas match said color-coded field of view cones, wherein said video display with said matching color-coded bordered areas displays live video emanating from said corresponding video cameras, wherein each video feed, bordered by said color-coded border matching its corresponding color-coded field of view cone, is displayed, wherein the video so displayed can be easily reconciled with its corresponding source.

19. The system of claim 1, wherein said system operates only within some limited range of speed, wherein:
said limited range of speed is between a full stop and a predetermined maximum system operating speed, wherein said limited range of speed causes the system to focus primarily on vehicle operation while bringing the vehicle to a stop, wherein passenger ingress and egress primarily occurs, and subsequently, bringing the vehicle back up to beyond said maximum operating speed, wherein passenger ingress and egress is not likely to occur.

20. The system of claim 1, further comprising an egress monitor, wherein said egress monitor provides an additional data gathering means not necessarily affixed to the perimeter of said vehicle, wherein said egress monitor provides said system the count of departing passengers at each stop of said vehicle, such that said analysis means can track said departing passengers accurately.
